(19) United States
(12) Patent Application Publication
(10) Pub. No.: US 2005/0001502 A1
(43) Pub. Date: Jan. 6, 2005

(54) DC brushless motor

(76) Inventors: Hiroyuki Yamazaki, Chiisagata-gun (JP); Takao Ono, Chiisagata-gun (JP)

Correspondence Address: BIRCH STEWART KOLASCH & BIRCH, PO BOX 747, FALLS CHURCH, VA, 22040-0747, US

(21) Appl. No.: 10/868,792

(22) Filed: Jun. 17, 2004

(30) Foreign Application Priority Data
Jun. 18, 2003 (JP) 2003-172719

(51) Int. Cl. H02K 21/12

(52) U.S. Cl. 310/156.47

(57) ABSTRACT

The DC brushless motor is capable of increasing an output power and reducing vibrations and noise. The DC brushless motor comprises: a magnet rotor, in which magnetic poles are polar-anisotropically oriented, wherein the magnetic poles are skewed with respect to an axial line of the magnet rotor.

### BACKGROUND OF THE INVENTION

The present invention relates to a DC brushless motor, more precisely relates to a DC brushless motor, which is capable of increasing an output power and reducing noise.

Conventionally, a magnet rotor, which is constituted by a magnet having high magnetic flux density and which is magnetized in the radial direction, is used so as to realize a compact and high power DC brushless motor. However, cogging is caused by radial magnetization, so that noise is increased.

To solve the problem of cogging, a DC brushless motor is disclosed in Japanese Patent Gazette No. 11-18377. A polar anisotropic magnet is employed as a rotor. In the polar anisotropic magnet rotor, a direction of magnetic field orientation is formed like an arc between different magnetic poles, and magnetic flux density distribution in the circumferential direction is like a sine wave. With this structure, cogging of the DC brushless motor can be restrained.

Another DC brushless motor is disclosed in Japanese Patent Gazette No. 2001-211581. A magnet rotor is made of a plastic, projections and concaves are formed in an outer circumferential face of the rotor, and the projections and the concaves are skewed with respect to an axial line. With this structure, cogging of the DC brushless motor can be restrained.

However, in the DC brushless motor disclosed in Japanese Patent Gazette No. 11-18377, the cogging cannot be efficiently restrained.

On the other hand, in the DC brushless motor disclosed in Japanese Patent Gazette No. 2001-211581, the rotor has an unbalanced shape, so that vibrations occur during operation.

### SUMMARY OF THE INVENTION

The present invention was invented to solve the problems of the conventional DC brushless motors.

An object of the present invention is to provide a DC brushless motor, which is capable of increasing an output power and reducing vibrations and noise.

To achieve the object, the present invention has following structure.

Namely, the DC brushless motor of the present invention comprises:

a magnet rotor, in which magnetic poles are polar-anisotropically oriented,

wherein the magnetic poles are skewed with respect to an axial line of the magnet rotor.

In the DC brushless motor of the present invention, the magnetic poles are skewed with respect to the axial line of the magnet rotor, so that vibrations and noise can be effectively reduced without reducing an output power (torque).

Note that, the magnet rotor is made of, for example, a rare earth metal.

### BRIEF DESCRIPTION OF THE DRAWINGS

Embodiments of the present invention will now be described by way of examples and with reference to the accompanying drawings, in which:

FIG. 1 is an explanation view showing a method of orientating magnetic poles of a magnet rotor of an embodiment;

FIG. 2 is a developed view of the magnet rotor, in which the magnetic poles are skewed;

FIG. 3 is a graph of magnetic flux density distribution in the circumferential direction of the magnet rotor, in which the magnetic poles are polar-anisotropically oriented and skewed;

FIG. 4 is a graph of magnetic flux density distribution in a circumferential direction of a magnet rotor as a comparative example, in which the magnetic poles are radial-anisotropically oriented;

FIG. 5 is a graph of magnetic flux density distribution in the circumferential direction of a conventional magnet rotor made of a sintered metal; and

FIG. 6A is a graph showing noise of the DC brushless motor of the embodiment; and

FIG. 6B is a graph showing noise of a conventional DC brushless motor.

### DETAILED DESCRIPTION OF THE EMBODIMENTS

Preferred embodiments of the present invention will now be described in detail with reference to the accompanying drawings.

In the DC brushless motor of the present invention, magnetic poles of a magnet rotor are polar-anisotropically oriented, and the magnetic poles are skewed with respect to an axial line of the magnet rotor.

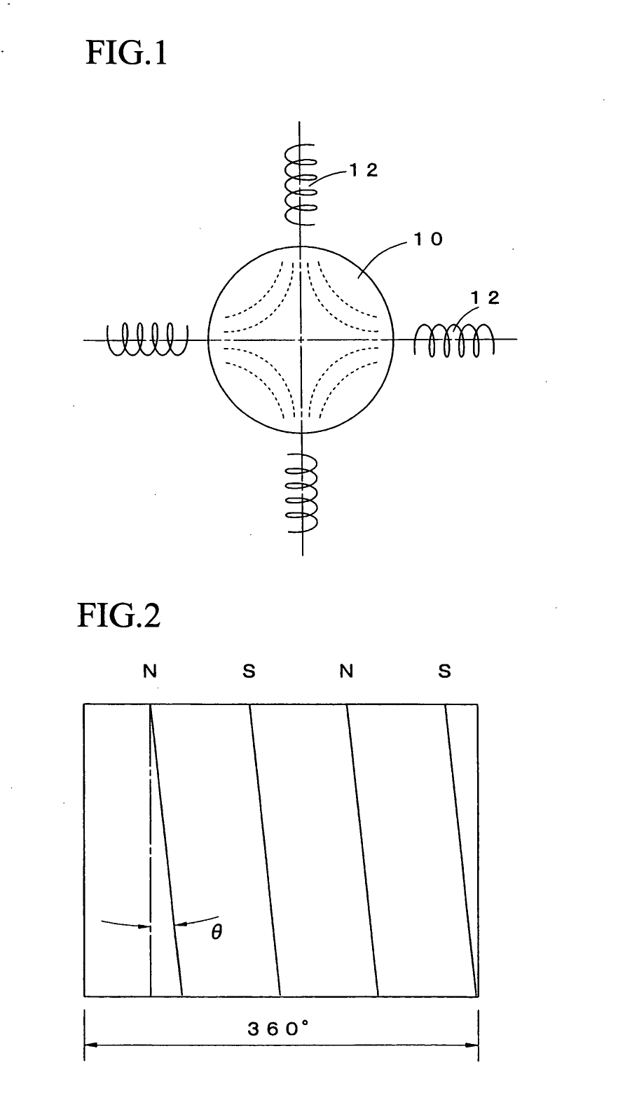

The polar anisotropic orientation of the magnet rotor will be explained with reference to FIG. 1. Coils 12 for orientation are provided around a magnet 10 for the rotor. By applying electric power to the coils 12, the magnetic poles are polar-anisotropically oriented in the magnet 10. A direction of magnetic field orientation in the magnet 10 is formed like an arc between adjacent different magnetic poles.

In FIG. 1, the magnet 10 has four magnetic poles, and N-poles and S-poles are alternately provided in the circumferential direction.

In the present embodiment, the magnetic poles are respectively skewed, at angle θ, with respect to an axial line of the magnet 10 (see FIG. 2).

As shown in FIG. 2, directions of magnetic field orientation are skewed with respect to the axial line of the magnet rotor. When the magnet 10 is manufactured, the magnetic poles may be diagonally arranged with respect to the angle θ.

FIG. 2 is developed view of an outer circumferential face of the magnet rotor, in which the magnetic poles are skewed at angle θ. Positions of the magnetic poles in the circumferential direction vary with respect to positions in the axial direction of the magnet rotor.

By polar-anisotropically orienting the magnetic poles and skewing them with respect to the axial line of the magnet rotor, the whole magnetic flux density distribution of the magnet 10 in the circumferential direction can be formed into a smooth sine wave.

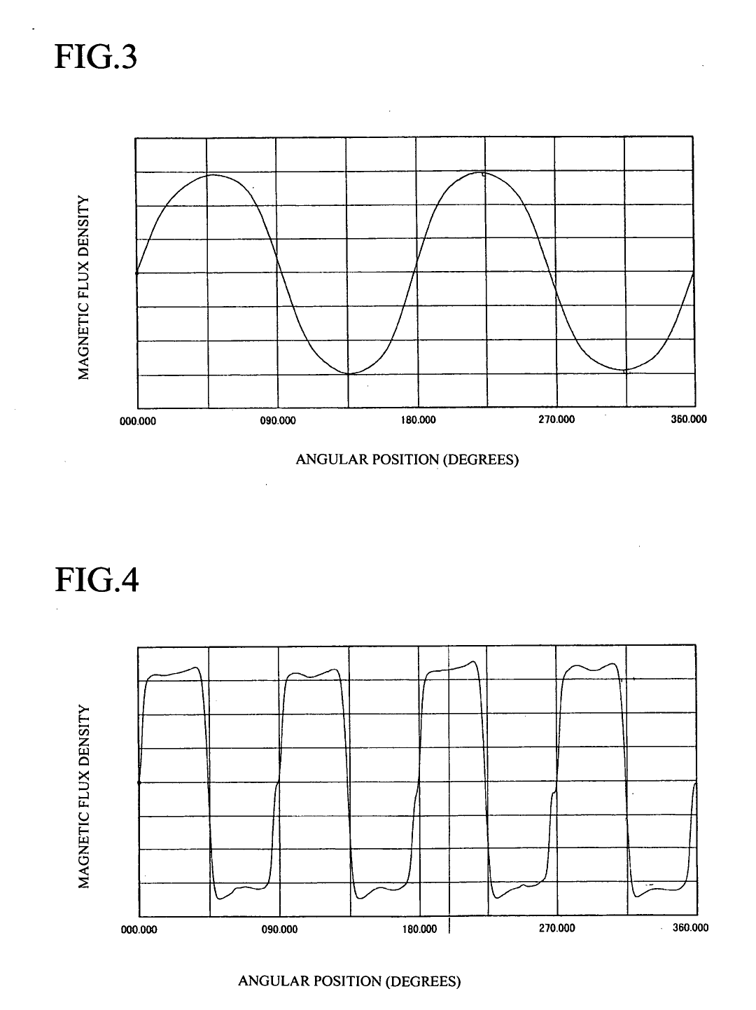

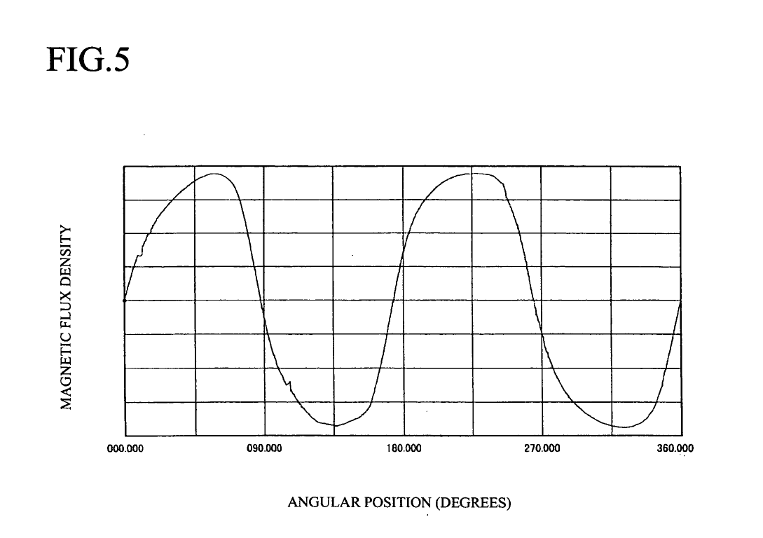

Magnetic flux density distribution of the polar anisotropic magnet 10, in which the magnetic poles are skewed, a sintered magnet and a radial anisotropic magnet, in circumferential directions, are respectively shown in FIGS. 3-5. Note that, the magnet 10 of FIG. 3 is made of a rare earth metal, e.g., Sm—Fe—N; the magnet of FIG. 4 is made of ferrite; the magnet of FIG. 5 is made of Nd—Fe—B.

According to the graphs of FIGS. 3-5, the magnetic flux density distribution of the smooth sine wave can be gained by employing the magnet rotor 10 of the present embodiment, in which the magnetic poles are polar-anisotropically oriented and skewed. With this feature, the magnet rotor can be smoothly rotated and can effectively reduce noise and vibrations.

The magnetic flux density of the present embodiment (see FIG. 3) is greater than those of the comparative examples of FIGS. 4 and 5. Namely, the DC brushless motor the present embodiment, which has the magnet rotor 10, is capable of outputting enough torque and reducing noise.

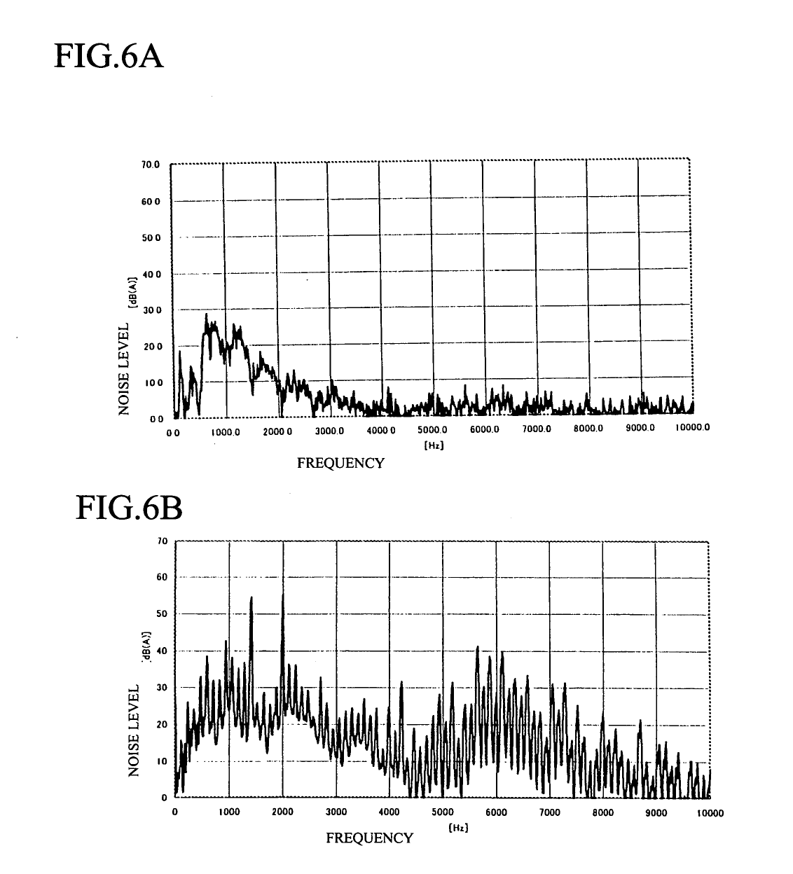

FIG. 6A is a graph showing noise of the DC brushless motor of the present embodiment; FIG. 6B is a graph showing noise of a conventional DC brushless motor.

In the present embodiment (FIG. 6A), the magnetic poles are polar-anisotropically oriented and skewed in the magnet rotor 10. On the other hand, in the comparative example (FIG. 6B), the magnet rotor is made of a sintered metal (Nd—Fe—B). According to the graphs, unlike the conventional DC brushless motor (the comparative example), the DC brushless motor of the present embodiment is capable of highly reducing noise.

Therefore, the DC brushless motor of the present embodiment can effectively reduce noise. Further, by employing the magnet rotor in which the magnetic poles are polar-anisotropically oriented and skewed, the magnetic flux density distribution can be formed into the smooth sine wave in the circumferential direction, so that a compact and quiet DC brushless motor can be realized without reducing torque.

The DC brushless motor of the present embodiment, which has high torque and which is capable of reducing noise, may be used for various uses. For example, the compact and quiet DC brushless motor is suitable for a driving motor of a vehicle.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A DC brushless motor,
comprising:
a magnet rotor, in which magnetic poles are polar-anisotropically oriented,
wherein the magnetic poles are skewed with respect to an axial line of said magnet rotor.

2. The DC brushless motor according to claim 1,
wherein said magnet rotor is made of a rare earth metal.
